(19) United States
(12) Patent Application Publication
(10) Pub. No.: US 2022/0393209 A1
(43) Pub. Date: Dec. 8, 2022

(54) Advanced Electrolytic Storage and Recovery of Hydrogen

(71) Applicant: Rodolfo Antonio Gomez, South Australia (AU)

(72) Inventor: Rodolfo Antonio Gomez, South Australia (AU)

(21) Appl. No.: 17/852,667

(22) Filed: Jun. 29, 2022

Related U.S. Application Data
(63) Continuation-in-part of application No. 16/629,674, filed on Jan. 9, 2020, now abandoned.

(30) Foreign Application Priority Data
Jul. 11, 2017 (AU) 2017902711
Oct. 8, 2017 (AU) 2017904058

(51) Int. Cl. H01M 8/0656; C25B 1/04; H01M 16/00; H01G 11/04

(52) U.S. Cl. CPC H01M 8/0656; C25B 1/04; H01M 16/003; H01G 11/04

(57) ABSTRACT

An apparatus for storing hydrogen as protons and electrons separately. The apparatus includes a DC power supply; a hydrogen electrolysis unit including a hydrogen tank adapted to contain hydrogen under pressure and in contact with one or more catalyst electrodes contained in the tank, the one or more catalyst electrodes in electrical connection with the DC power supply; and an electron storage unit for storing electrons, the electron storage unit in electrical connection with the DC power supply and separated from the hydrogen electrolysis unit. In a proton generation mode, the DC power supply is configured to operate the one or more catalyst electrodes in anode mode to catalyze oxidation of hydrogen in the hydrogen tank to form and store protons on or near the one or more electrodes and store generated electrons in the electron storage unit.

### CROSS-REFERENCE TO RELATED APPLICATIONS

This application is a continuation-in-part of U.S. application Ser. No. 16/629,674, filed Jan. 9, 2020, which is the United States national phase of International Application No. PCT/AU2018/000102 filed Jul. 11, 2018, and claims priority to Australian Provisional Patent Application No. 2017902711 filed Jul. 11, 2017 and Australian Provisional Patent Application No. 2017904058 filed Oct. 8, 2017, the disclosures of which are hereby incorporated by reference in their entirety.

### INCORPORATION BY REFERENCE

The following publications are referred to in the present application and their contents are hereby incorporated by reference in their entirety:
U.S. Pat. No. 7,326,329 “Commercial Production of Hydrogen from Water” in the name of Rodolfo Antonio M. Gomez,
U.S. Pat. No. 6,475,653 “Non-diffusion Fuel Cell and a Process of Using a Fuel Cell” in the name of RMG Services Pty. Ltd.,
U.S. Pat. No. 5,882,502 “Electrochemical System and Method” in the name of RMG Services Pty. Ltd., and
PCT Patent No. WO 2016/134401 A1 “Electrolytic Storage of Hydrogen” of Rodolfo Antonio Gomez.

The content of each of these documents is hereby incorporated by reference in their entirety.

### TECHNICAL FIELD

The present disclosure relates to apparatus and processes for the electrolytic storage of hydrogen as a proton.

### BACKGROUND

The United Nations' Intergovernmental Panel on Climate Change recommended that carbon emissions must be reduced by 40 to 70% by 2050 and to zero by 2100 or the world will suffer catastrophic climate change. Measurements of NASA and NOAA show that 2016 is the hottest year on record since records began in 1880 and 2017 is only slightly less. In the Paris Climate Change Conference of December 2015, the 195 signatory countries have agreed to reduce emissions to keep the world temperature from rising 2 degrees C. by 2030. A recent study by James Cook University indicated that many more species could be saved if global warming was kept to no more than 1.5 degrees C. The world is not taking enough measures to meet this critical temperature target.

There is an ongoing need for electric storage systems. TESLA installed in 2016 in the mid-north of South Australia, the largest lithium ion battery with a capacity of 100 megawatts. This battery is able to store capacity for 1 hour and 20 minutes. However, this is inadequate because in South Australia energy storage of at least 1,200 kilowatts is required for several days during heat waves in summer.

There is thus a need to provide energy storage systems that overcome one or more of the problems associated with known energy storage systems.

### SUMMARY

The present disclosure relates to the electrolytic storage of hydrogen as a proton and a separate storage of the electrons that are accessed when the electron is added to the proton to produce hydrogen.

According to a first aspect of the present disclosure, there is provided an apparatus for storing hydrogen as protons and electrons separately, the apparatus comprising:

a DC power supply;

a hydrogen electrolysis unit comprising a hydrogen tank adapted to contain hydrogen under pressure and in contact with one or more catalyst electrodes contained in the tank, the one or more catalyst electrodes in electrical connection with the DC power supply;

an electron storage unit for storing electrons, the electron storage unit in electrical connection with the DC power supply and separated from the hydrogen electrolysis unit;

wherein the apparatus is also operable in a proton generation mode in which the DC power supply is configured to operate the one or more catalyst electrodes in anode mode to catalyze oxidation of hydrogen in the hydrogen tank to form and store protons on or near the one or more electrodes and store generated electrons in the electron storage unit.

In certain embodiments of the first aspect, the apparatus is also operable in a hydrogen recovery mode in which the DC power supply is configured to operate the one or more catalyst electrodes in cathode mode wherein protons on the one or more catalyst electrodes are converted to hydrogen under vacuum by recovering the electrons from the electron storage unit, under conditions to remove the hydrogen from a surface of the one or more electrodes as it is formed and remove it from the hydrogen tank.

In certain embodiments of the first aspect, the apparatus further comprises a humidifier configured to humidify the hydrogen gas with water before delivery to the hydrogen tank.

In certain embodiments of the first aspect, the one or more catalyst electrodes are metal impregnated electrodes wherein the metal is selected from one or more of the group consisting of platinum and platinum-iridium.

In certain embodiments of the first aspect, the electron storage unit is selected from one or more of the group consisting of: a capacitor, an electrolytic system, and oxygen ions contained in electrodes.

In certain embodiments of the first aspect, the electron storage unit is a capacitor with high surface area formed from an alloy of metals or oxide of metals such as carbon, rare earth metals, nickel, magnesium and/or aluminum hydrides.

In certain embodiments of the first aspect, the electron storage unit is an electrolytic system and reactions used in the chemical storage of the electrons have a low Eₒ such as the cupric-cuprous reaction that has an Eₒ of 0.153 volts.

In certain embodiments of the first aspect, the electron storage unit is oxygen ions contained in electrodes and the process of generating hydrogen gas results in conversion of the oxygen ions to oxygen.

In certain embodiments of the first aspect, the hydrogen electrolysis unit and the electron storage unit are separate but consolidated into one vessel.

According to a second aspect of the present disclosure, there is provided an energy storage device comprising the apparatus of the first aspect.

According to a third aspect of the present disclosure, there is provided a process for storing hydrogen as protons and electrons separately, the process comprising:

contacting hydrogen in a hydrogen tank under pressure with one or more catalyst electrodes and applying a DC power supply under conditions to operate the electrodes in anode mode and catalyze oxidation of the hydrogen at the one or more electrodes to form and store protons on or near the one or more electrodes, and

storing generated electrons in a separate electron storage unit.

In certain embodiments of the third aspect, the process further comprises applying the DC power supply under conditions to operate the electrodes in cathode mode to convert the hydrogen protons stored on the one or more catalyst electrodes to hydrogen under vacuum by recovering the electrons from the electron storage unit, and removing the hydrogen from the surface of the electrodes as it is formed.

In certain embodiments of the third aspect, the process further comprises storing the protons on or near the one or more electrodes under a vacuum.

In certain embodiments of the third aspect, the process further comprises humidifying the hydrogen before delivery to the hydrogen tank.

In certain embodiments of the third aspect, the one or more catalyst electrodes are platinum impregnated electrodes.

In certain embodiments of the third aspect, the temperature of the proton electrode is maintained above 25 degrees Celsius for the recovery of the hydrogen.

In certain embodiments of the third aspect, the electron storage unit is selected from one or more of the group consisting of: a capacitor, an electrolytic system, and oxygen ions contained in electrodes.

In certain embodiments of the third aspect, the electron storage unit is a capacitor with very high surface area formed from an alloy of metals or oxide of metals such as carbon, rare earth metals, nickel, magnesium and/or aluminum hydrides.

In commercial applications, the platinum coated electrodes that store the protons and the capacitors that store the electrons may be small in size and electrically connected in series and parallel to produce the voltage and current required for the commercial application.

In certain embodiments of the third aspect, the electron storage unit is an electrolytic system and reactions used in the chemical storage of the electrons have a low Eₒ such as the cupric-cuprous reaction that has an Eₒ of 0.153 volts.

In certain embodiments of the third aspect, the electron storage unit is oxygen ions contained in electrodes and the process of generating hydrogen gas results in conversion of the oxygen ions to oxygen.

The apparatus and process of the first to third aspects may be used to provide energy storage in an electrolytic system for cyclic energy such as solar, wind or wave, or to provide fuel for land, water and air vessels.

### BRIEF DESCRIPTION OF DRAWINGS

Embodiments of the present invention will be discussed with reference to the accompanying drawings wherein:

FIG. 1 is a plot of the specific energy of hydrogen and fuel cell systems compared to the specific energy of various battery systems (available at www.energy.gov/sites/prod/files/2014/03/f9/thomas_fcev_vs_battery_evs.pdf);

FIG. 2 is a schematic diagram showing the concept of the storage of hydrogen protons and the recovery of hydrogen;

FIG. 3 is a schematic diagram of a copper mesh electrode coated with platinum electrolytically deposited at 2 grams per square metre. The electrodes are contained in a stainless steel vessel to allow for hydrogen to be pressurized and also for a vacuum to be applied;

FIG. 4 is a schematic diagram showing a system whereby electrons are stored in a separate structure during the catalysis of the hydrogen and when the hydrogen is required, the electrons are returned to the hydrogen proton to produce the hydrogen;

FIG. 5 is a schematic diagram of the catalysis of hydrogen to produce protons;

FIG. 6 is a schematic diagram showing the production of hydrogen from stored protons;

FIG. 7 is a schematic diagram of the implementation of the processes shown in FIGS. 5 and 6;

FIG. 8 is a schematic diagram showing the production of protons and the recovery of hydrogen from a fuel cell;

FIG. 9 is a schematic diagram showing an embodiment of a hydrogen storage tank;

FIG. 10 is a schematic diagram showing an embodiment of support structure for a hydrogen storage tank;

FIG. 11 is a schematic diagram showing an embodiment of a fuel cell proton storage tank;

FIG. 12 is a schematic diagram showing an embodiment of an advanced capacitor for storing large quantities of electrons;

FIG. 13 is a schematic diagram showing an embodiment of a system for proton storage with fuel cell electrodes—capacitors;

FIG. 14 is a schematic diagram showing an embodiment of a system for hydrogen recovery with fuel cell electrodes—capacitors;

FIG. 15 is a schematic diagram showing an embodiment of a system for proton storage with fuel cell electrodes—Cu⁺⁺/Cu⁺ storage of protons;

FIG. 16 is a schematic diagram showing an embodiment of a system for hydrogen recovery with fuel cell electrodes—Cu⁺/Cu⁺⁺ recovery of hydrogen;

FIGS. 17A and 17B are schematic diagrams showing an embodiment of a system for dry storage of protons and oxygen ions. FIG. 17A (left figure) shows the configuration for hydrogen proton and oxygen ion production and FIG. 17B (right figure) shows the configuration for hydrogen and oxygen recovery;

FIG. 18 is a schematic diagram showing loading and unloading from a hydrogen proton and electron storage tank;

FIG. 19 is a schematic diagram showing hydrogen providing reliable energy storage for renewable energy;

FIG. 20 is a schematic diagram showing an embodiment of a system of the present disclosure applied to propeller and jet aircraft. Not shown is an engine with a high speed motor driving a turbine similar to a jet engine;

FIG. 21 is a schematic diagram showing an embodiment of a system of the present disclosure applied to a submarine;

FIG. 22 is a schematic diagram showing an embodiment of a system for hydrogen recovery with fuel cell electrodes and capacitors for dry storage of protons and electrons. FIG. 22A (left figure) shows the configuration for hydrogen proton and electron production and FIG. 22B (right figure) shows the configuration for hydrogen recovery;

FIG. 23 is a schematic diagram showing an embodiment of an apparatus for hydrogen storage and recovery using a 5 kilowatt commercial fuel cell to produce and store protons and a 10 million Farad capacitor to store electrons;

FIG. 24 is a plot of hydrogen concentration (left vertical axis) and nitrogen flow rate (right vertical axis). The data were generated using the apparatus shown in FIG. 23;

FIG. 25 is a plot of gas concentration (right vertical axis) and nitrogen flow rate (left vertical axis). The data were generated using the apparatus shown in FIG. 23;

FIG. 26 is a schematic diagram showing an embodiment of an apparatus for hydrogen storage and recovery using a 5 kilowatt commercial Horizon fuel cell to produce and store protons and a 20 million Farad capacitor to store electrons;

FIG. 27 is a schematic diagram showing an embodiment of an apparatus for hydrogen storage and recovery using a fuel cell to produce and store protons and a fuel cell to store electrons in oxygen;

FIG. 28 is a schematic diagram showing an embodiment of an apparatus for hydrogen storage and recovery using a fuel cell to produce and store protons and a fuel cell to store electrons in oxygen;

FIG. 29 is a plot of hydrogen concentration and nitrogen flow rate. The data were generated using the apparatus shown in FIG. 28; and

FIG. 30 is a plot of gas concentration (right vertical axis) and nitrogen flow rate (left vertical axis). The data were generated using the apparatus shown in FIG. 28.

### DESCRIPTION OF EMBODIMENTS

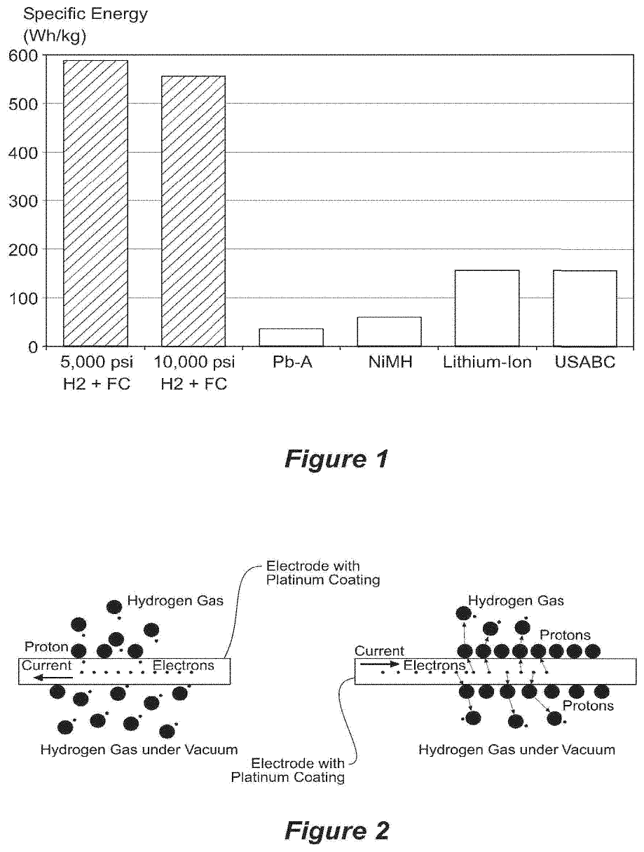

The present disclosure arises from the inventor's research on apparatus and processes that can be used to store hydrogen as protons and recover the hydrogen without the use of a liquid or gel carrier and, similarly, to store oxygen as ions and then recover the oxygen. It is notable that 2 grams of hydrogen has a volume of 22.4 litres at standard temperature and pressure while 2 grams of hydrogen protons have a volume of 5.0585×10⁻¹⁸ litres. For oxygen, 32 grams of oxygen has a volume of 22.4 litres at standard temperature and pressure. The calculated volume of 1 kilogram of oxygen ions is 0.315625 litres. The volume of 1 kilogram of liquid oxygen is 1.141 litres. Hydrogen has an energy density of 142 mega-joules per kilogram while a lithium ion battery has an energy density of 0.3 to 0.8 mega-joules per kilogram. As shown in FIG. 1, the specific energy of a lithium ion battery is about 150 Wh/kg, whilst the specific energy of a hydrogen fuel cell at 5,000 psi and 10,000 psi is between 500 and 600 Wh/kg. In contrast, the specific energy of the apparatus described herein is calculated to be 8,508 Wh/kg if only the weight of the tank is considered.

The present inventor undertook extensive research to determine how to store hydrogen successfully as a proton without the use of a liquid or gel carrier. The inventor has extensive experience in hydrogen fuel cell electrodes in the early 1900s and is aware that the method of deployment of the platinum catalyst is crucial to the success of the catalysis of the electron removal. In initial research, electrically deposited platinum coated titanium mesh electrodes were not successful for storing hydrogen protons. Further research was carried out where the electrodes were replaced with fuel cell type electrodes. However, catalysis of the hydrogen could not be achieved.

Following this research, the inventor determined that to store the hydrogen successfully as a proton, electrons removed from the protons needed to be stored in another vessel. These electrons can then be recovered and delivered to the protons when required.

Thus, provided herein is an apparatus 10 for storing hydrogen as protons and electrons separately. As used herein, the term “storing hydrogen as protons and electrons separately”, or similar terms, means that the protons and electrons are electronically isolated from one another during storage. The apparatus comprises a DC power supply 12, a hydrogen electrolysis unit 14 and an electron storage unit 16.

The hydrogen electrolysis unit comprises a hydrogen tank 18 adapted to contain hydrogen under pressure and in contact with one or more catalyst electrodes 20 contained in the tank. The one or more catalyst electrodes 20 are in electrical connection with the DC power supply 12.

The electron storage unit 16 is used for storing electrons and it is in electrical connection with the DC power supply 12 and is separated from the hydrogen electrolysis unit 14.

The apparatus 10 can be operated in a proton generation mode in which the DC power supply 12 is configured to operate the one or more catalyst electrodes 20 in anode mode to catalyze oxidation of pressurized hydrogen in the hydrogen tank 18 at the one or more catalyst electrodes 20 to form and store protons on or near the one or more electrodes in the hydrogen tank and store generated electrons in the electron storage unit 16.

In addition, the apparatus 10 can be operated in a hydrogen recovery mode in which the DC power supply 12 is configured to operate the one or more catalyst electrodes 20 in cathode mode wherein hydrogen protons on the one or more electrodes are converted to hydrogen under vacuum by recovering the electrons from the electron storage unit 16 and adding these to the hydrogen protons, under conditions to remove the hydrogen from a surface of the one or more electrodes 20 as it is formed and remove it from the hydrogen tank 18.

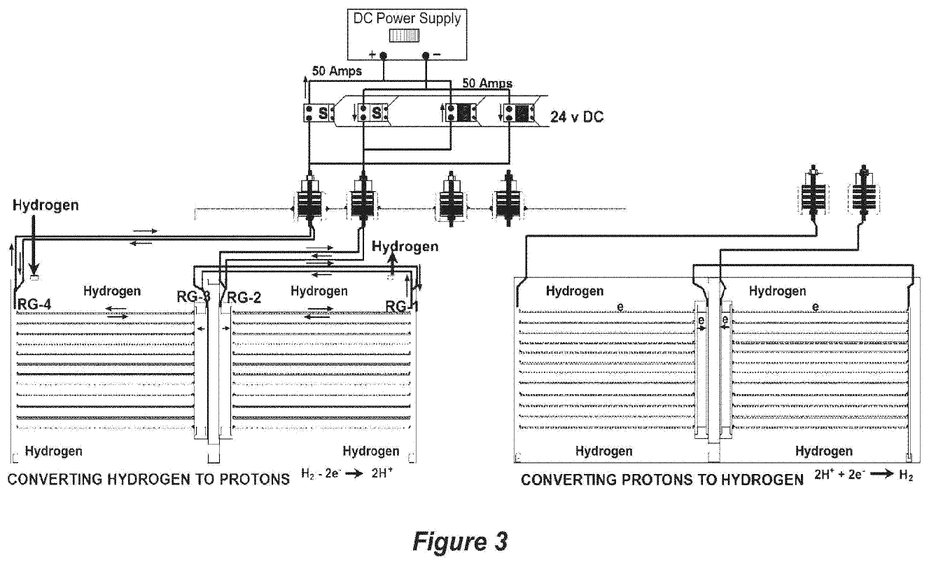

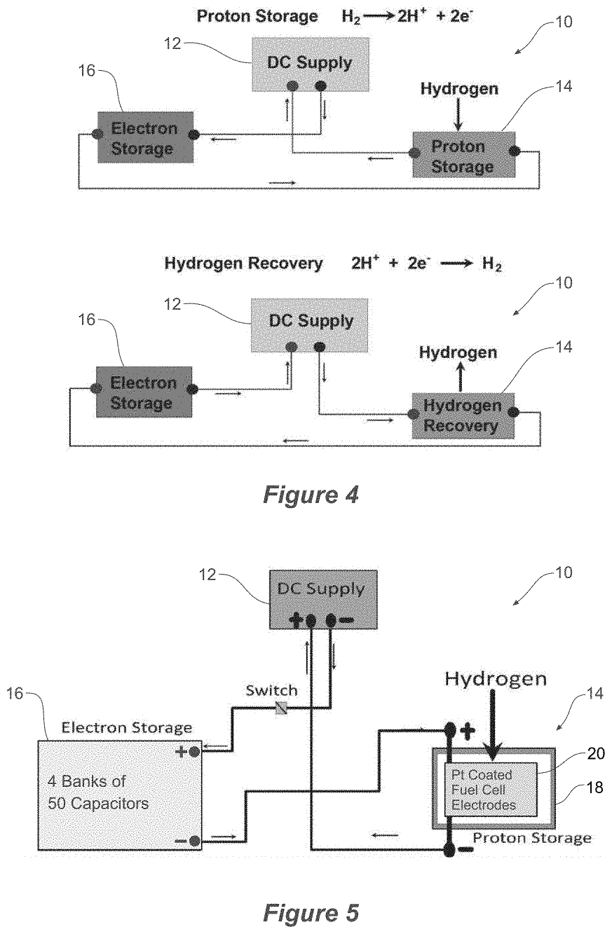

Apparatus according to embodiments of the present disclosure are shown schematically in FIGS. 2 to 4. The production of the protons is assisted by the use of a catalyst such as platinum or platinum-iridium in an electrode simulating a hydrogen fuel cell reaction. The hydrogen is under pressure so that the hydrogen is in contact with the catalyst on the catalyst electrodes 20. The electrodes 20 are operated in anode mode in which electrons are removed from the electrode 20 and the hydrogen protons are stored on the electrode 20, giving the electrode a positive charge. The protons are stored on the electrode surface in a single layer or multi-layer. When hydrogen is required, the electrodes 20 are subjected to high vacuum before the electrodes are operated in cathode mode in which electrons are introduced thereby allowing hydrogen atoms to be formed. To avoid electron removal from the catalyst, the electrodes 20 are subjected to vacuum so that the hydrogen gas leaves the electrode surface as soon as the hydrogen gas is formed.

Electrons can be stored in the electron storage unit 16 in any one or more of the following ways:
Electrons can be stored in a capacitor,
Electrons can be stored chemically, and/or
Electrons can be stored in oxygen ions.

In some embodiments, the apparatus 10 includes a humidifier for the humidifying the hydrogen. Any commercially available humidifier can be used. Typically, the hydrogen can be humidified by contacting a hydrogen stream with water such that some of the water is transferred to the hydrogen stream. The hydrogen may be humidified to from about 10% to about 100% humidity, such as about 10%, about 15%, about 20%, about 25%, about 30%, about 35%, about 40%, about 45%, about 50%, about 55%, about 60%, about 65%, about 70%, about 75%, about 80%, about 85%, about 90%, about 95% or about 100%. Depending on the composition of the catalyst electrodes and the temperature in the hydrogen tank, humidifying the hydrogen may assist in the proton formation step. Humidification may not be required if highly efficient catalysts or higher temperatures are used.

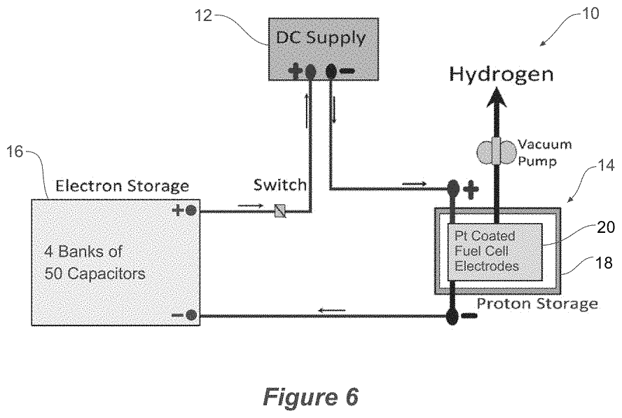

An embodiment of the apparatus is shown in FIG. 5 wherein electrons are stored in a bank of capacitors while the protons are stored in fuel cell type electrodes in the hydrogen electrolysis unit. The proton storage is under high vacuum. Hydrogen is generated in the same apparatus as shown in FIG. 6.

For the apparatus shown schematically in FIGS. 5 and 6, a 60 watt fuel cell Model H-60 from Horizon Fuel Cells was modified so that only hydrogen was fed to the anode side and the air part was closed so that no air was admitted. This 60 watt fuel cell produces 5 amperes at 12 volts DC.

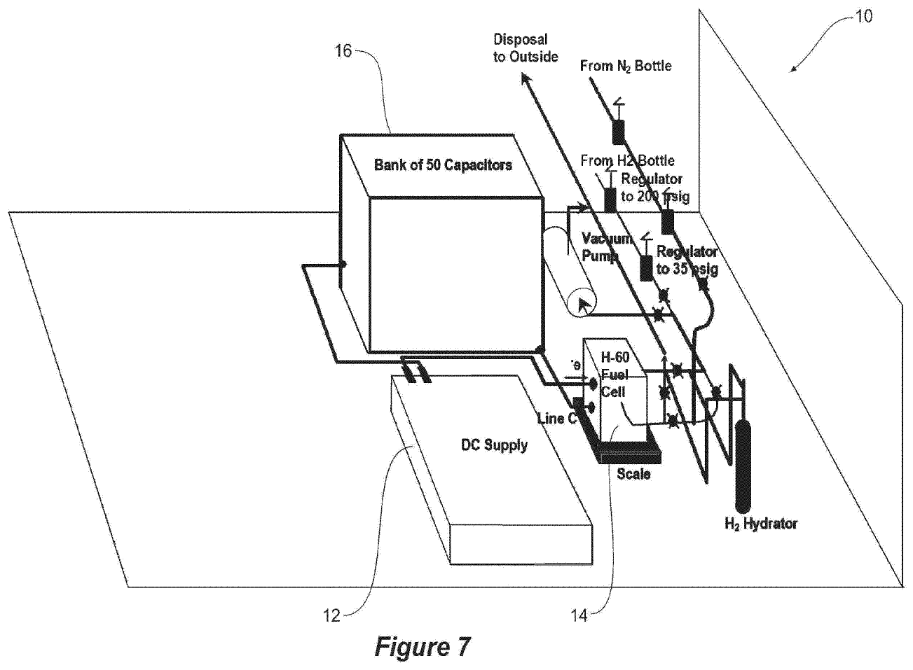

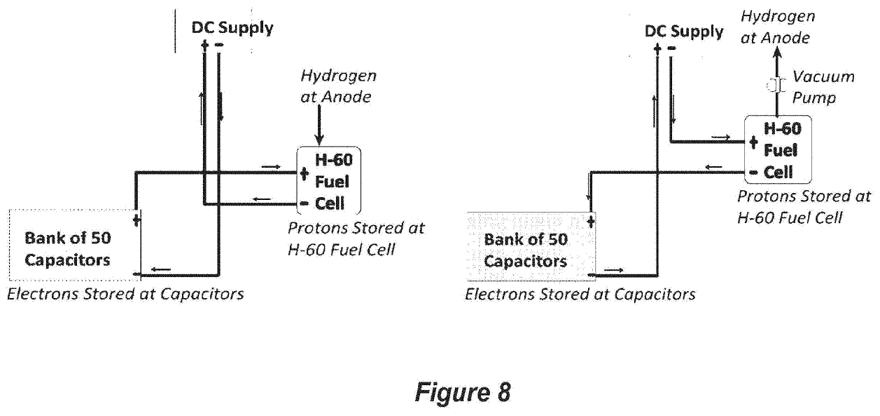

In the apparatus shown in FIG. 7, hydrogen is sourced from a high pressure bottle and then reduced to about 7 psig before it is introduced into the anode of the H-60 fuel cell to produce the protons on the anode electrode. Nitrogen gas is used to flush the lines and equipment before hydrogen is introduced. The DC supply is a programmable Isotech IPS2010 with voltage 0-20 V and current 0 to 10 A. The 50 capacitors connected in parallel are Maxwell K2 Series Model BCAP3000P270K04 with capacity of 3000F (150,000F total). The hydrogen flowmeter is an Alcat Scientific M-205LPM-D-DM/10M and the hydrogen on-line process analyser is H2SCAN, Model HY-OPTIMA 700B. FIG. 8 shows schematically the production of protons (left diagram) and the recovery of hydrogen (right diagram) from the H-60 fuel cell.

In all experiments, the circuit is closed as shown in FIG. 5 and FIG. 6. The open circuit did not work. Table 1 shows the results when dry hydrogen is fed to the H-60 fuel cell.

TABLE 1
Proton Accumulation with Dry H₂ Anode, Dry H₂ Cathode and
Closed Circuit

| I_{DC} | V_{DC} |
|---|---|
| (A) | (V) |
| 0.000 | 0.00 |
| 0.020 | 3.00 |
| 0.034 | 5.00 |
| 0.066 | 10.00 |
| 0.088 | 15.00 |
| 0.112 | 20.00 |

With dry hydrogen the current, which indicates the amount of hydrogen converted to protons, is very small. At 5 volts, the current was only 0.034 amperes.

Table 2 shows the significant increase in hydrogen being converted to protons when the hydrogen is humidified.

TABLE 2
Proton Accumulation with Humidified H₂ Anode Humidified H₂ Cathode

| Duration | I_{DC} | V_{DC} | I_{CAP} | V_{CAP} |
|---|---|---|---|---|
| (hh:mm) | (A) | (V) | (A) | (V) |
| 0:00 | 0.000 | 0.00 | 0.0 | 0.0003 |
| 0:02 | 5.000 | 1.71 | 5.0 | 0.0135 |
| 0:05 | 5.000 | 1.42 | 5.0 | 0.0204 |
| 0:10 | 5.000 | 1.55 | 5.0 | 0.0338 |
| 0:15 | 5.000 | 1.62 | 5.0 | 0.0467 |
| 0:20 | 5.000 | 1.68 | 5.0 | 0.0586 |
| 0:30 | 5.000 | 1.78 | 5.0 | 0.0843 |
| 0:40 | 5.000 | 1.88 | 5.0 | 0.1101 |
| 0:50 | 5.000 | 1.98 | 5.0 | 0.1355 |
| 1:00 | 5.000 | 2.09 | 5.0 | 0.1598 |
| 1:10 | 5.000 | 2.21 | 5.0 | 0.1841 |
| 1:20 | 5.000 | 2.35 | 5.0 | 0.2082 |
| 1:30 | 5.000 | 2.51 | 5.0 | 0.2345 |
| 2:10 | 5.000 | 5.91 | 5.0 | 0.3312 |

V_{DC} is the voltage at the DC supply and V_{cap} is the voltage from the capacitor. The current was limited to 5 amperes as this was the maximum allowed by the H-60 Fuel Cell. The voltage steadily increased from 0 to 5.91 after 2 hours and 10 minutes as the capacitor was loaded with electrons at a voltage of 0.3312 volts. The temperature of the humidifier was 30 degrees C. Increasing this temperature did not increase the current, a measure of the protonisation of the hydrogen.

This shows that hydrogen protonation increased substantially when the hydrogen in contact with the fuel cell electrodes was humidified.

The H-60 fuel cell was subjected to vacuum and then the current was reversed to deliver the electrons from the capacitors to the anode of the H-60 fuel cell. The difficulty was measuring the small amount of hydrogen produced which was too low to activate the hydrogen flow sensor. The solution was to add a constant flow of nitrogen to the hydrogen. Specifically, nitrogen at 1 litre per minute was fed to the hydrogen meter after the vacuum pump discharge. Nitrogen at 1 litre per minute was also fed to the box around the H-60 fuel cell. The gas inlet and outlet of the cathode were sealed and the gas outlet of the anode was sealed and the inlet of the anode was connected to the vacuum pump.

The hydrogen from the H-60 fuel cell was detected as shown in Table 3 when the temperature of the H-60 fuel Cell reached 51.2 degrees C. Most likely, there was less energy required at 51.2 degrees C. to allow the production of hydrogen from the protons.

TABLE 3
Production of Hydrogen from H-60 Fuel Cell

| Stack | Normalised Current | Hydrogen Evolution |
|---|---|---|
| Temperature (° C.) | through stack (A/V_{cell}) | (mol·s⁻¹) |
| 25.4 | 0.045 | 0 |
| 35.6 | 0.045 | 0 |
| 51.2 | 0.058 | 6.69 10⁻⁸ |

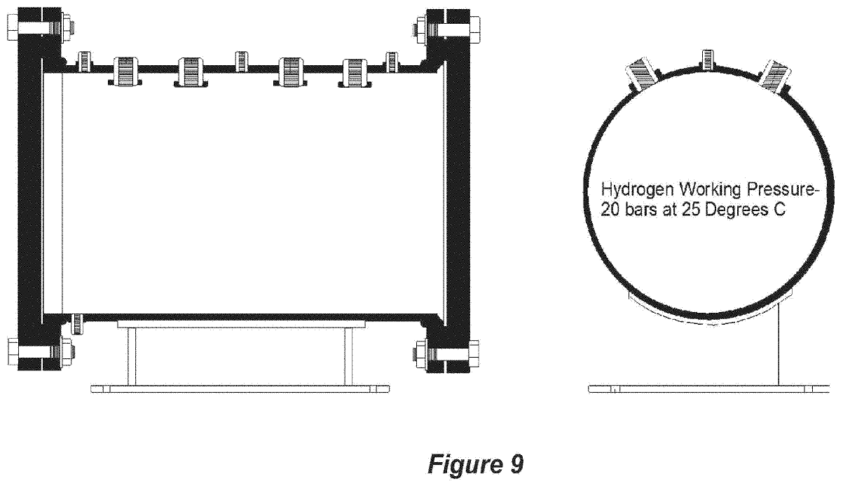

Preferably, the anode electrode containing the hydrogen protons is enclosed so that high vacuum can be applied to the recovery of hydrogen. An example of a suitable hydrogen tank is shown in FIG. 9. The tank is made of 316SSL stainless steel. The design of the tank allows for electrodes to be located inside the tank to allow hydrogen protons to be produced and stored. The tank is fitted with holes to install terminals to connect power to the electrodes inside the tank. Flanges on both ends allow the electrode assembly to be installed.

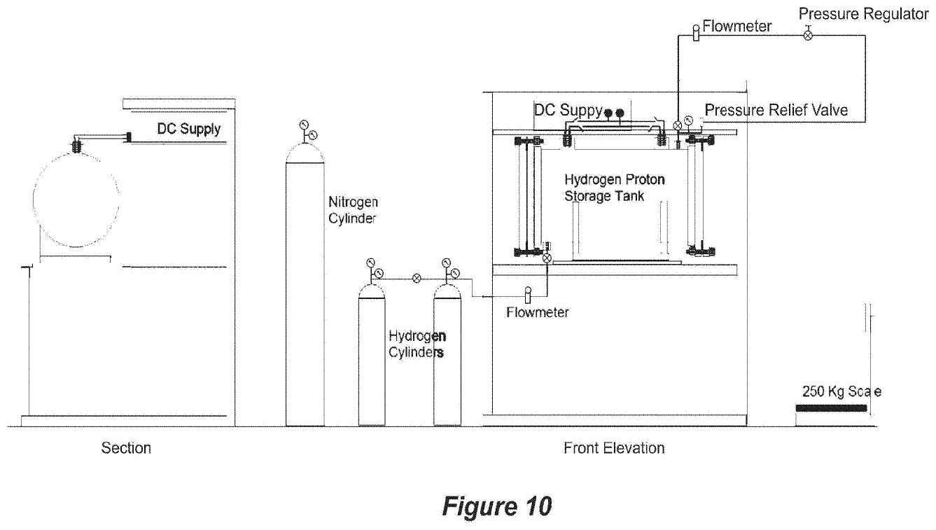

FIG. 10 shows a support structure for the hydrogen storage tank. There is room for the DC supply to be installed.

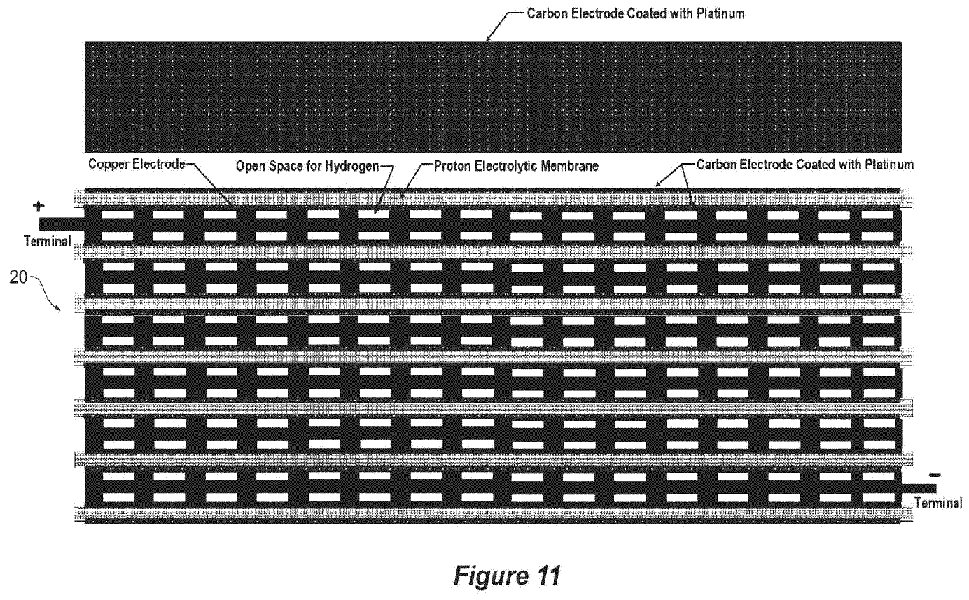

A construction of a suitable electrode 20 is shown in FIG. 11. The electrode 20 may be a proton-exchange membrane (otherwise known as polymer-electrolyte membrane (PEM)) which is a semipermeable membrane that allows for separation of reactants and transport of protons while blocking a direct electronic pathway through the membrane. For example, the electrode 20 is made up of anodes with fine catalyst material on both sides of a membrane electrode assembly (MEA) which is a plastic material such as a fluoropolymer such as Nafion™ that allows protons to travel through but not electrons. The catalyst may be any catalytic material known to those skilled in the art. Suitable catalysts include platinum, platinum-iridium, or other catalytic metals or alloys. Copper electrodes with slots to allow hydrogen to contact the anodes are sandwiched between the MEA electrodes. The copper electrodes may be replaced by other conductive materials such as aluminum and carbon. Not shown are carbon sheets on the surface of the anodes that allow hydrogen to pass through. There is an inlet (positive) terminal and an outlet (negative) terminal.

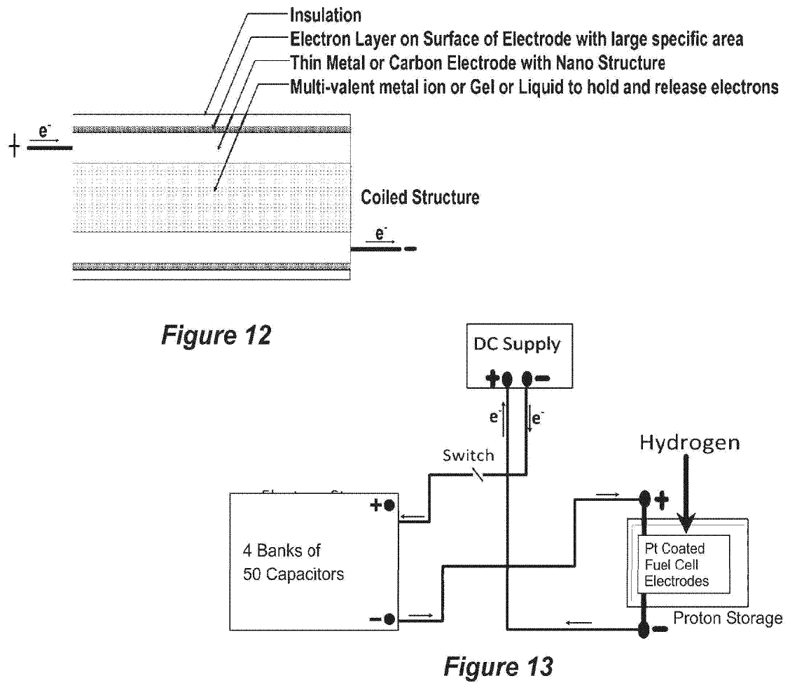

The construction of the capacitor is shown in FIG. 12. The outer surface has a very high specific surface area utilizing nanotechnology and the metal may be made of alloys such as carbon, rare earth metals, magnesium, nickel, aluminum and other metal hydrides that will have a large up-take of electrons in their chemical and crystal structure.

On the platinum coated anode electrodes, the hydrogen under pressure is oxidized to form electrons and protons as occurs in PEM Fuel Cells. The protons remain on the surface of the anode and the electrons are taken to the positive of the DC supply and the negative delivers the electrons to the capacitor. The capacitor consists of a bank of 4×50 capacitors.

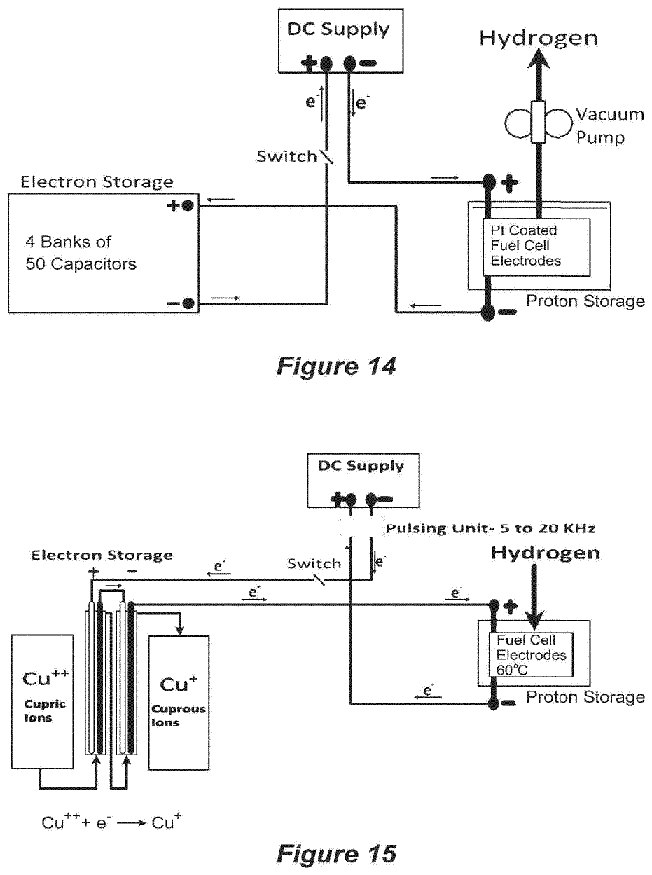

FIG. 13 shows how the electrons are taken from the capacitors and delivered to the anode of the electrodes inside the hydrogen tank by the DC supply. At this stage, the hydrogen tank is at high vacuum so that as soon as the hydrogen gas is formed, it leaves the surface of the anode to prevent the reverse reaction from occurring. The hydrogen exits the hydrogen tank. Hydrogen is recovered as shown in FIG. 14.

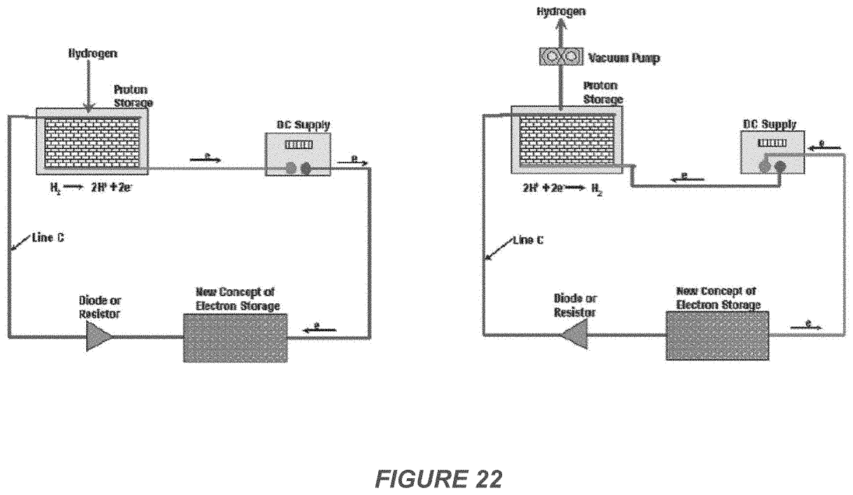

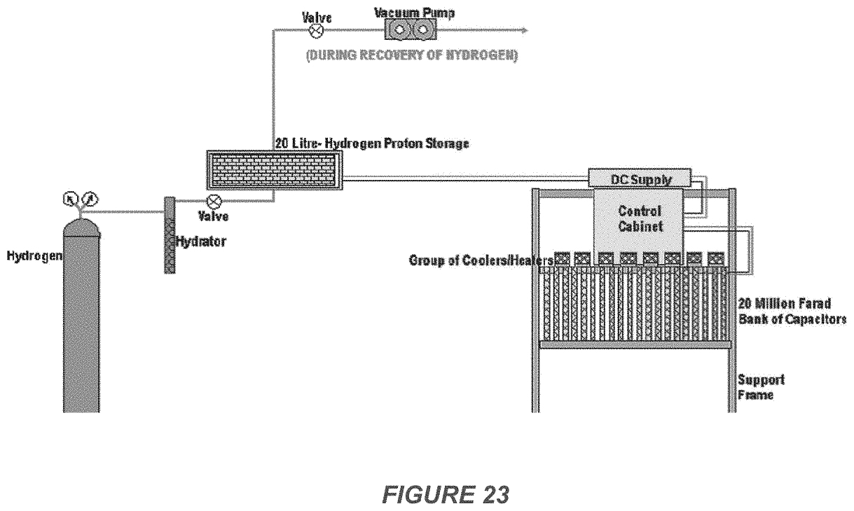

FIGS. 22 and 23 show apparatus for the production and storage of protons in a fuel cell and electrons in a capacitor. A 5 kilowatt commercial fuel cell was used to produce and store the protons and a 10 million Farad capacitor was used to store electrons. The protons were stored in a 5,000 watt fuel cell and the electrons stored in a 10 million farad capacitor made up of 20×500,000 farad capacitors connected in parallel. The 20 litre proton storage fuel cell contains electrodes with a fine platinum coating. The electrons are transmitted by a DC supply to the bank of 10 million Farad capacitors. The temperature of the capacitors is maintained by a bank of heaters/coolers. Using this apparatus protons can be stored in the 20 litre reactor and hydrogen recovered. During the recovery operation, the proton storage is kept under vacuum to extract the hydrogen from the surface of the electrodes. Charging was done over 4 days at 100 volts and 8 psig hydrogen only. Recovery of hydrogen was carried out at 100 volts and vacuum at −50 kpag resulting in an initial surge of 15 percent hydrogen. Nitrogen was passed flowing at 0.1 liters per minute. A small flow of nitrogen is necessary to operate the percentage hydrogen metre. The results show that hydrogen has been stored and then recovered. Please note that the storage was carried out at only 8 psig as this was the rating of the fuel cell. The proton storage is similar to the electrodes in a fuel cell where electrodes coated with very fine platinum hold the protons as electrons are removed and stored separately. The initial potential required for the storing operation is low but increases as the storing operation progresses. Line C with the diode may or may not be required. In the recovery operation, the proton storage is placed under vacuum so that as the hydrogen is formed on the surface of the electrode, the hydrogen flies off the electrode surface.

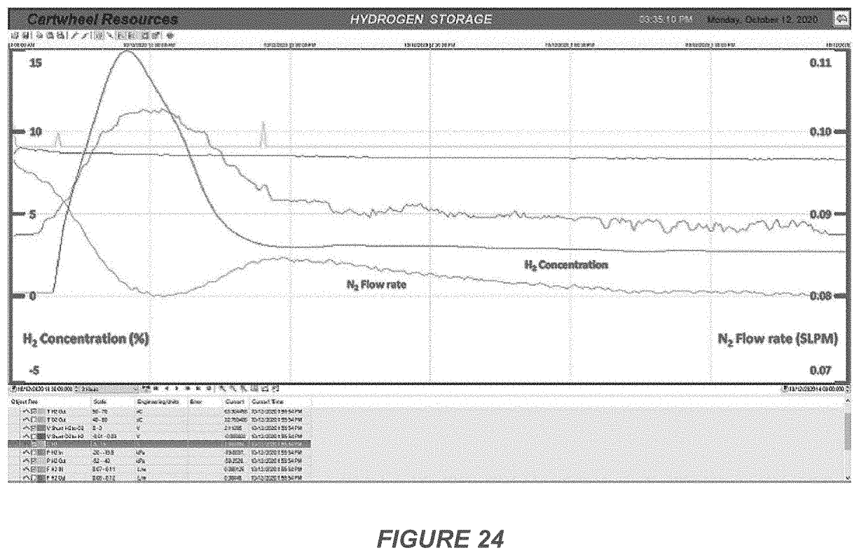

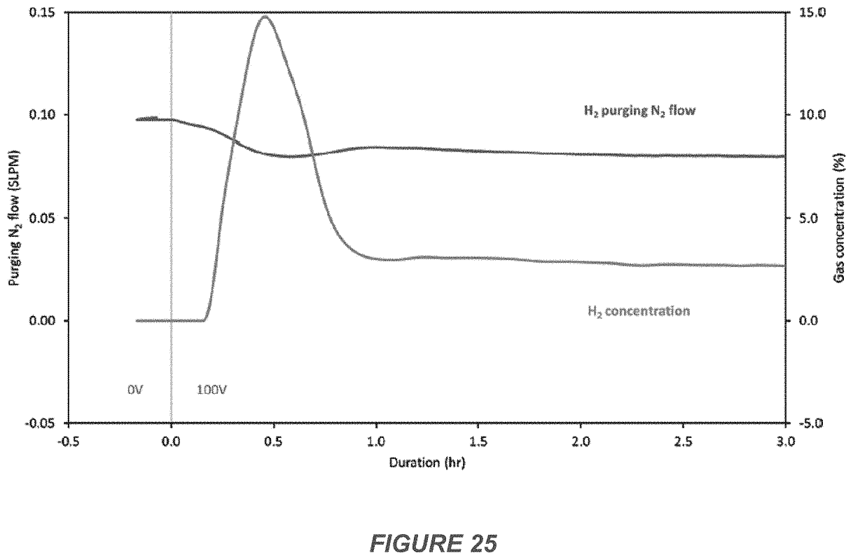

Results of experiments conducted using the apparatus shown in FIG. 23 are provided in FIGS. 24 and 25. The experiments confirmed that hydrogen can be stored as a proton and then recovered as hydrogen peaking at 16% hydrogen. The hydrogen was stored at a low pressure of about 8 psig and temperature of 55 C. The recovery voltage was 100 volts.

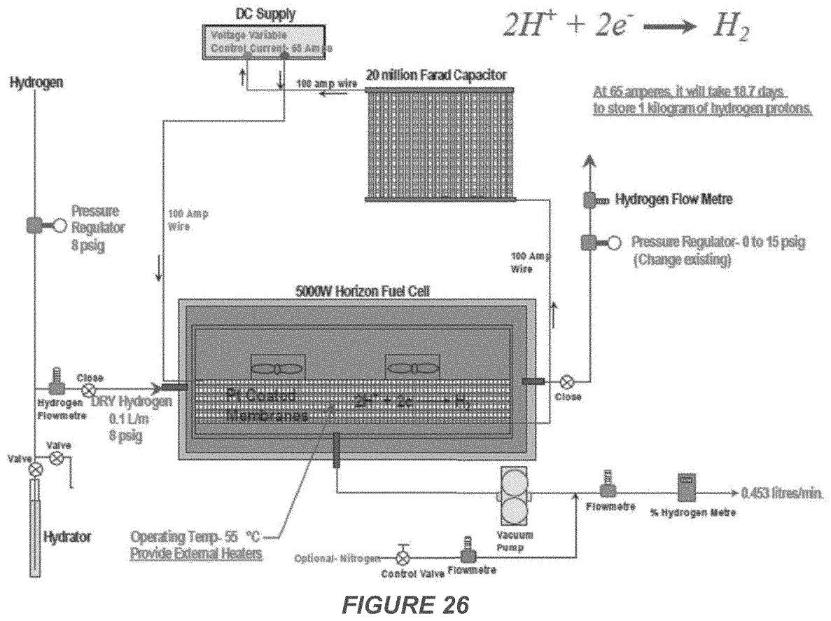

FIG. 26 shows an apparatus for the storage of electrons with a 20 million Farad capacitor and using a 5000 W Horizon fuel cell.

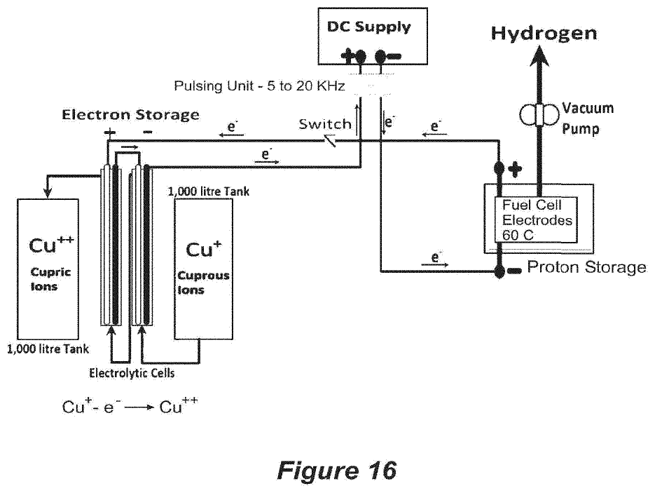

In an alternative method for storing electrons shown in FIG. 15, the hydrogen is stored as protons on platinum coated electrodes while the electrons are stored chemically. In this example, the cupric-cuprous reaction with Eₒ=0.15 volts, is used to store and then recover the electrons. The proton generation and hydrogen recovery unit is operated at 60 degrees C. and 100 psi nitrogen. The DC supply was set at floating voltage and floating amperes. Voltage and amperes were recorded. Checks were made with pulsing at 5 and 20 KHz. A resistor is applied if necessary. Humidified hydrogen was applied at 100 psi and 60 degrees C. The amperes were set to 10 Amp and the voltage was recorded. The electrolytic cell may be connected in Unipolar cathode mode. The cupric ion is converted to cuprous ion with the electrolytic cells connected in Unipolar cathode-cathode mode. To recover the hydrogen, the cuprous ion is converted to cupric ion as shown on FIG. 16 to release the electrons. The electrolytic cells are connected in Unipolar anode mode. A high vacuum was maintained at 60 degrees C. It is estimated that five 1,000 litre tanks of cupric sulfate will be required to store 5 kg of protons. This method may be used where large hydrogen storage is required such as in storing renewable energy or in large installations on land and ships at sea.

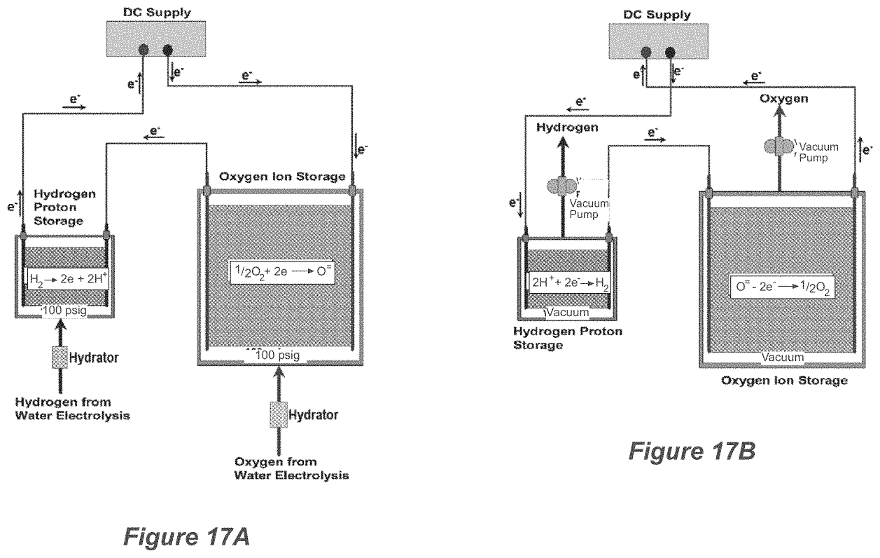

The storage and recovery of hydrogen protons and oxygen ions with a carrier was discussed in international patent application WO 2016/134401 A1. In this invention, the storage of hydrogen as a proton and oxygen as an ion is carried out without a carrier. This is very appropriate because in the electrolysis of water, hydrogen and oxygen are produced. Normally, it is convenient to release the oxygen to the atmosphere and then recover it later in the fuel cell operation; however, in some applications such as hydrogen submarines and rocket type airplanes, it is necessary to carry oxygen as fuel. FIG. 17A shows the electrons being removed from the hydrogen by the DC supply and the electrons being added to oxygen to produce oxygen ions. In FIG. 17B, electrons are removed from the oxygen ions producing the oxygen and the electrons are added to the hydrogen protons to produce hydrogen. If 1 kilogram of hydrogen proton is stored, there will be a need to store 8 kilograms of oxygen ion. In FIGS. 17A and 17B, the hydrogen tank is as shown in FIG. 9 and two similar tanks can be used for the oxygen storage.

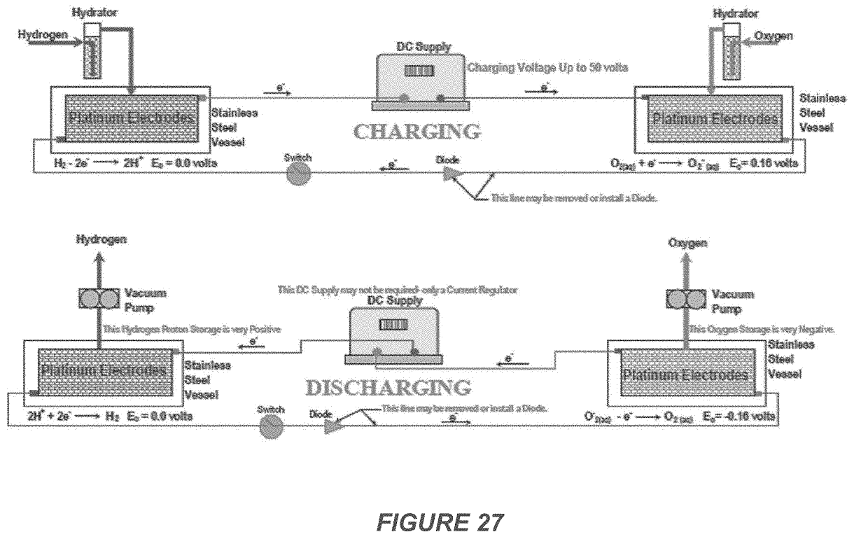

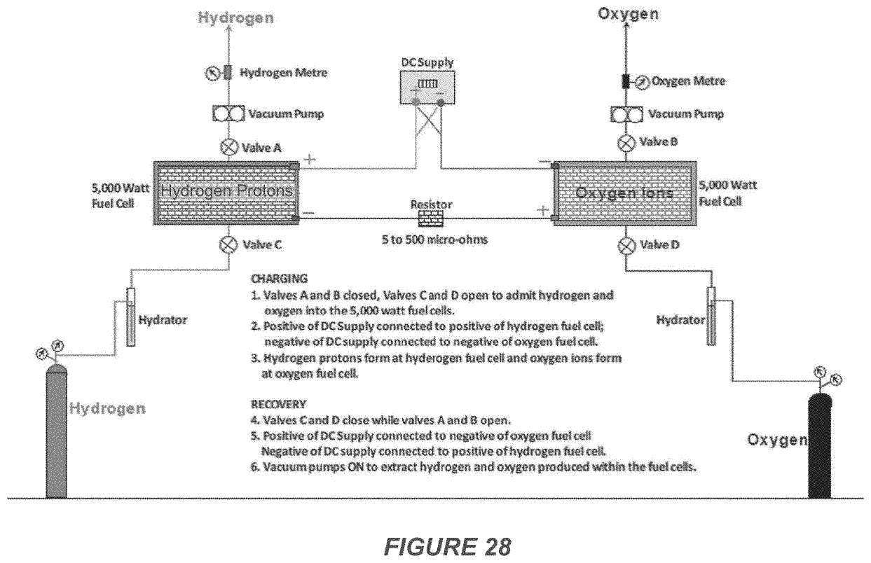

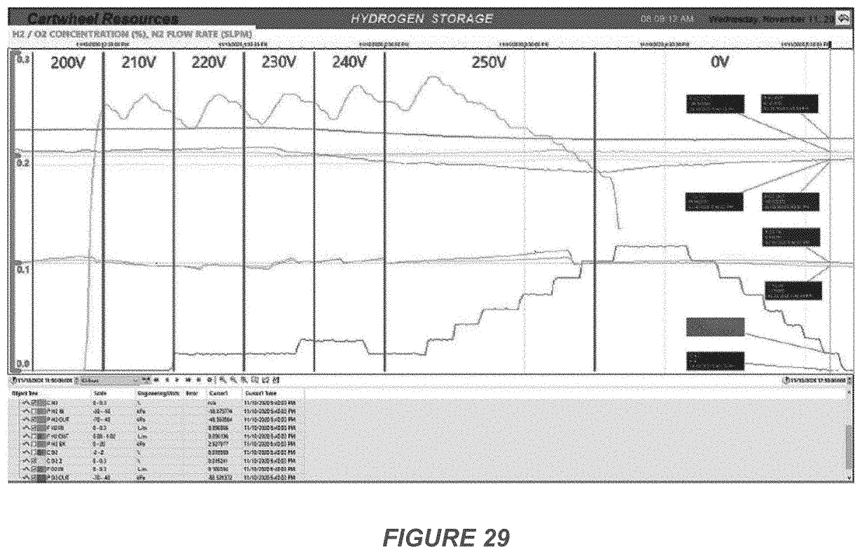

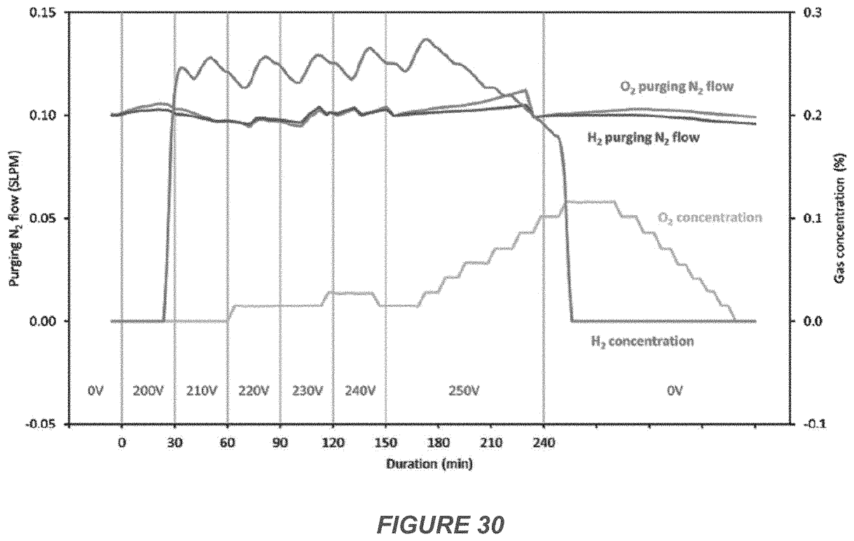

Detailed apparatus for production of protons and storage of electrons in oxygen is shown in FIGS. 27 and 28. These apparatus may be suitable for use in applications where it is desirable to have the hydrogen and oxygen in the same vessel such as in a submarine, or a rocket type aircraft or in Grid Scale Storage. During charging, the energy required to remove the electron from the hydrogen is very small when the electrodes are coated with fine platinum. The potential required to add the electron to the oxygen atom is about 0.16 volts. The hydrogen proton and the oxygen ions are stored in 5,000 watt fuel cells making use of the platinum coated electrodes in the fuel cells. Storing was carried out for 48 hours at 250 volts and 50 kpag and about 60 C. Recovery was carried out at 200 to 250 volts at −50 kpag vacuum. The graphs shown in FIGS. 29 and 30 demonstrate that hydrogen and oxygen have been stored and then recovered. The results show that the hydrogen recovery came first while oxygen recovery lagged and was observed only after the recovery voltage was stopped. In this experiment the process that was slow was the storage and recovery of oxygen. It is possible the catalyst in the 5,000 watt fuel cell may not be suitable for the ionization of the oxygen atom. As charging proceeds, the potential required increases but this is not a problem as the charging is carried out outside the vessel. During discharging in the vessel where hydrogen and oxygen are formed, the oxygen storage is very negative while the hydrogen storage is very positive and electrons will tend to flow from the oxygen to the hydrogen storage. The driving potential may only be required towards the latter part of the discharging operation in the vessel.

Aside from the applications of this invention mentioned in international patent application WO 2016/134401, the following are examples of the commercial applications of the dry storage of hydrogen.

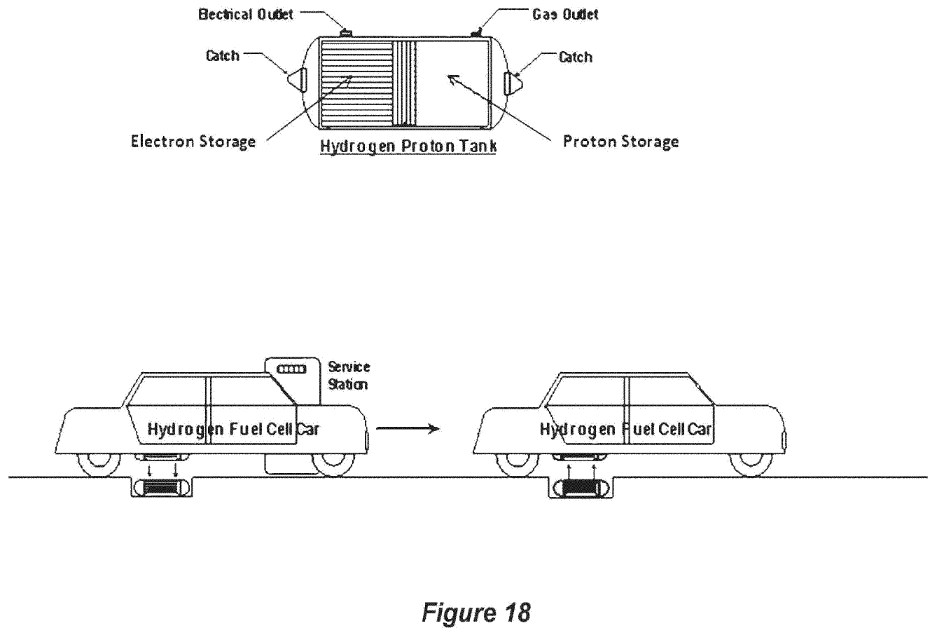

FIG. 18 shows how convenient and safe it is to use the apparatus of the present disclosure in storing hydrogen protons at low pressure in a personal vehicle. The hydrogen storage can be optimized so that a family hydrogen vehicle may need to load 1 hydrogen tank with 50 kilograms of hydrogen protons every 6 months. This storage can be applied to water and low speed aircrafts driven by propellers.

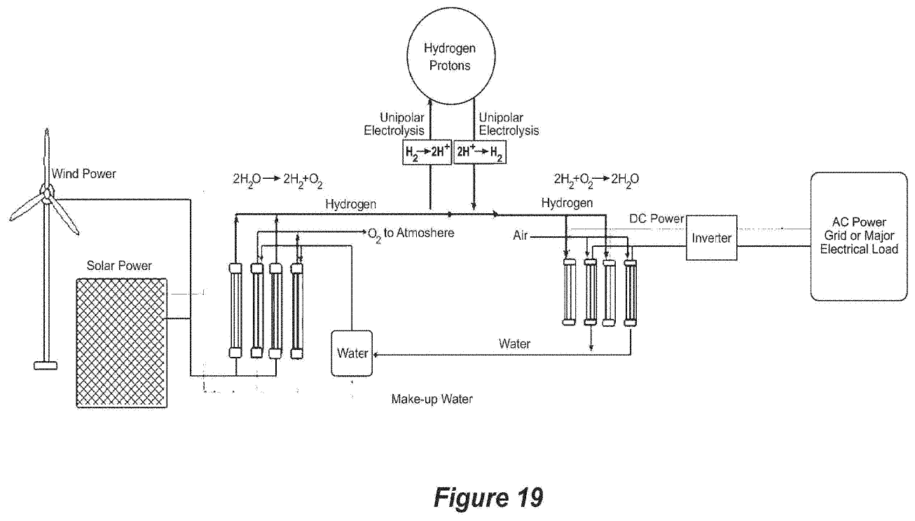

A major application of the apparatus of the present disclosure is in providing low cost reliable energy storage to cyclic renewable energy such as wind or solar (FIG. 19). Hydrogen proton storage can provide several days or weeks aside from the normal cycle of day and night or daily fluctuations in wind energy. In this apparatus, Unipolar electrolysis of water (e.g. as described in U.S. Pat. No. 7,326,329, GB Patent No. 2409865 or Australian Patent No. 2004237840) is used to produce hydrogen from water. Unipolar electrolysis will produce substantially more hydrogen for the same energy used to produce 1 mol of hydrogen by conventional water electrolysis. Non-diffusion hydrogen fuel cells are used to produce water from hydrogen and oxygen (e.g. as described in U.S. Pat. No. 6,475,653, GB Patent No. 2344208 or Australian Patent No. 733227).

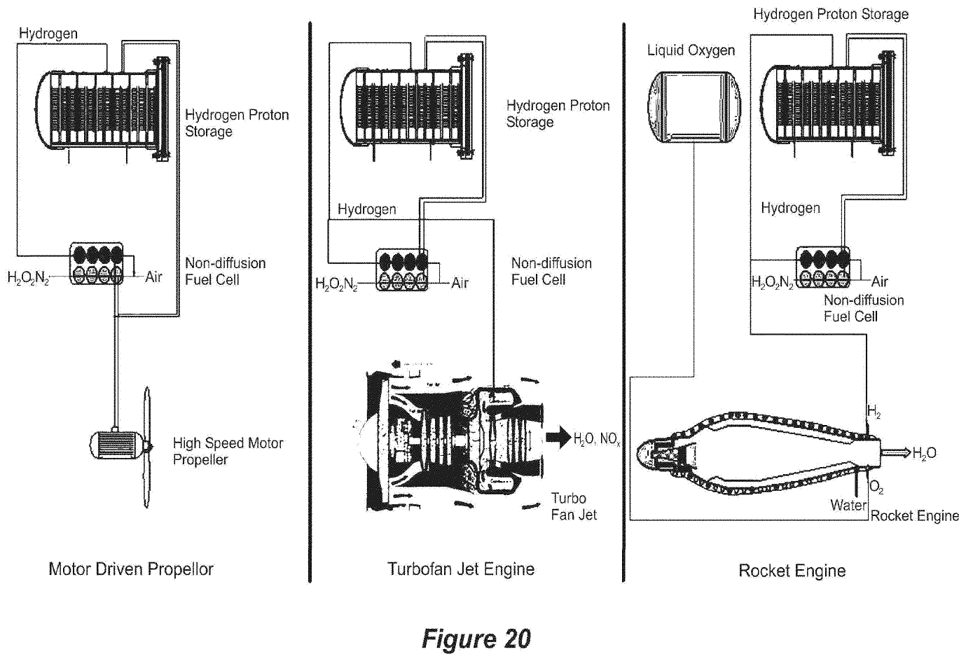

Current aircraft are major carbon polluters because the carbon dioxide, unburnt hydrocarbons and nitrous oxide are delivered high in the atmosphere where the effect on climate change is at a maximum. The apparatus of the present disclosure can be applied to low speed aircraft using propellers or up to rocket type aircrafts as shown in FIG. 20.

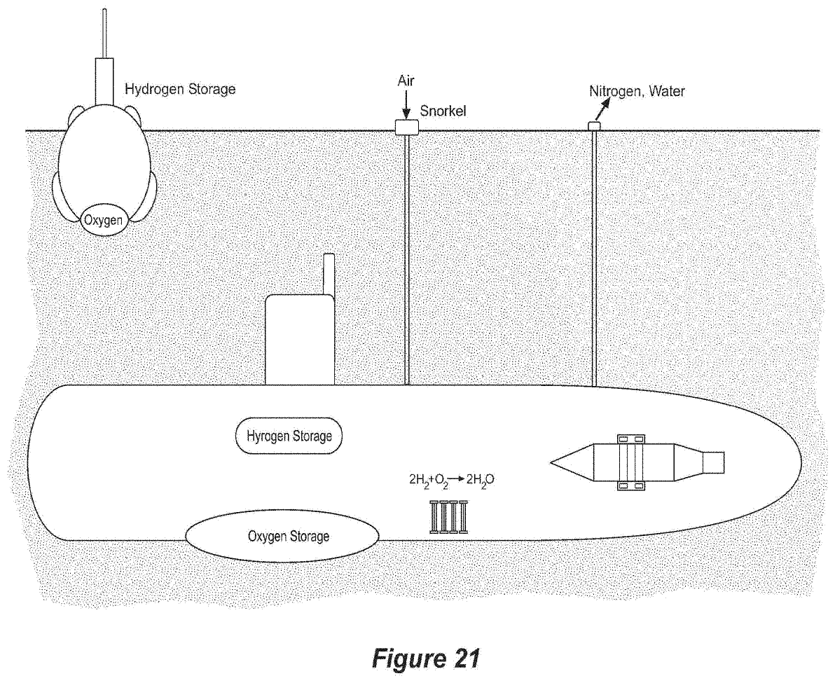

The apparatus of the present disclosure can also be applied to submarines and ships which will be cheaper and safer than nuclear powered submarines and warships (FIG. 21). The external drive may be located closer to mid-ship to provide greater maneuverability. If the enemy is on port side, the port engine will be stopped and only the starboard engine will run to provide even greater stealth in the operation of the hydrogen submarines.

Throughout the specification and the claims that follow, unless the context requires otherwise, the words “comprise” and “include” and variations such as “comprising” and “including” will be understood to imply the inclusion of a stated integer or group of integers, but not the exclusion of any other integer or group of integers.

The reference to any prior art in this specification is not, and should not be taken as, an acknowledgement of any form of suggestion that such prior art forms part of the common general knowledge.

It will be appreciated by those skilled in the art that the invention is not restricted in its use to the particular application described. Neither is the present invention restricted in its preferred embodiment with regard to the particular elements and/or features described or depicted herein. It will be appreciated that the invention is not limited to the embodiment or embodiments disclosed, but is capable of numerous rearrangements, modifications and substitutions without departing from the scope of the invention as set forth and defined by the following claims.

1. An apparatus for storing hydrogen as protons and electrons separately, the apparatus comprising:
a DC power supply;
a hydrogen electrolysis unit comprising a hydrogen tank adapted to contain hydrogen under pressure and in contact with one or more catalyst electrodes contained in the tank, the one or more catalyst electrodes in electrical connection with the DC power supply;
an electron storage unit for storing electrons, the electron storage unit in electrical connection with the DC power supply and separated from the hydrogen electrolysis unit;
wherein in a proton generation mode the DC power supply is configured to operate the one or more catalyst electrodes in anode mode to catalyze oxidation of hydrogen in the hydrogen tank to form and store protons on or near the one or more electrodes and store generated electrons in the electron storage unit.

2. The apparatus of claim 1, wherein the apparatus is also operable in a hydrogen recovery mode in which the DC power supply is configured to operate the one or more catalyst electrodes in cathode mode wherein protons on the one or more catalyst electrodes are converted to hydrogen under vacuum by recovering the electrons from the electron storage unit, under conditions to remove the hydrogen from a surface of the one or more electrodes as it is formed and remove it from the hydrogen tank.

3. The apparatus of claim 1, wherein the apparatus further comprises a humidifier configured to humidify the hydrogen with water before delivery to the hydrogen tank.

4. The apparatus of claim 1, wherein the one or more catalyst electrodes are metal impregnated electrodes wherein the metal is selected from one or more of the group consisting of platinum and platinum-iridium.

5. The apparatus of claim 1, wherein the electron storage unit is selected from one or more of the group consisting of: a capacitor, an electrolytic system, and oxygen ions contained in electrodes.

6. The apparatus of claim 5, wherein the electron storage unit is a capacitor with high surface area formed from an alloy of metals or oxide of metals.

7. The apparatus of claim 5, wherein the electron storage unit is an electrolytic system and reactions used in the chemical storage of the electrons have a low Eₒ.

8. The apparatus of claim 5, wherein the electron storage unit is oxygen ions contained in electrodes and the process of generating hydrogen gas results in conversion of the oxygen ions to oxygen.

9. An energy storage device comprising the apparatus of claim 1.

10. A process for storing hydrogen as protons and electrons separately, the process comprising:
contacting hydrogen in a tank under pressure with one or more catalyst electrodes and applying a DC power supply under conditions to operate the electrodes in anode mode and catalyze oxidation of the hydrogen at the one or more electrodes to form and store protons on or near the one or more electrodes, and
storing generated electrons in a separate electron storage unit.

11. The process of claim 10, further comprising applying the DC power supply under conditions to operate the electrodes in cathode mode to convert the hydrogen protons stored on the one or more catalyst electrodes to hydrogen under vacuum by recovering the electrons from the electron storage unit, and removing the hydrogen from the surface of the electrodes as it is formed.

12. The process of claim 10, further comprising storing the protons on or near the one or more electrodes under a vacuum.

13. The process of claim 10, further comprising humidifying the hydrogen before delivery to the hydrogen tank.

14. The process of claim 10, wherein the one or more catalyst electrodes are metal impregnated electrodes wherein the metal is selected from one or more of the group consisting of platinum and platinum-iridium.

15. The process of claim 10, wherein the temperature of the electrode is maintained above 25 degrees Celsius for the recovery of the hydrogen.

16. The process of claim 10, wherein the electron storage unit is selected from one or more of the group consisting of: a capacitor, an electrolytic system, and oxygen ions contained in electrodes.

17. The process of claim 16, wherein the electron storage unit is a capacitor with very high surface area formed from an alloy of metals or oxide of metals such as carbon, rare earth metals, nickel, magnesium and/or aluminum hydrides.

18. The process of claim 16, wherein the electron storage unit is an electrolytic system and reactions used in the chemical storage of the electrons have a low Eₒ such as the cupric-cuprous reaction that has an Eₒ of 0.153 volts.

19. The process of claim 16, wherein the electron storage unit is oxygen ions contained in electrodes and the process of generating hydrogen gas results in conversion of the oxygen ions to oxygen.

20. The process of claim 10, wherein the proton storage and the electron storage are separate but consolidated into one vessel.

21. The apparatus of claim 6, wherein the alloy is made from carbon, rare earth metals, nickel, magnesium and/or aluminium hydrides.

22. The apparatus of claim 7, wherein the reaction used in the chemical storage of the electrons is the cupric-cuprous reaction that has an Eₒ of 0.153 volts.
